(19) United States
(12) Patent Application Publication
(10) Pub. No.: US 2009/0042003 A1
(43) Pub. Date: Feb. 12, 2009

(54) Biodegradable plyboard and method of manufacture

(76) Inventors: Patrick Govang, Ithaca, NY (US); Jason Salfi, Ithaca, NY (US); Anil Netravali, Ithaca, NY (US)

Correspondence Address: JAECKLE FLEISCHMANN & MUGEL, LLP, 190 Linden Oaks, ROCHESTER, NY, 14625-2812, US

(21) Appl. No.: 12/058,739

(22) Filed: Mar. 30, 2008

Related U.S. Application Data
(60) Provisional application No. 60/909,325, filed on Mar. 30, 2007.
(60) Provisional application No. 61/014,169, filed on Dec. 17, 2007.

(51) Int. Cl. B32B 5/16; B32B 21/04; B32B 5/02; A63C 17/00

(52) U.S. Cl. 428/220; 428/537.1; 428/323; 428/292.4; 280/87.042

(57) ABSTRACT

A ply material comprising laminated plies of wood and/or bamboo affixed together by a layer of biodegradable soy protein resin fiber structures impregnated with soy protein resin.

### FIELD OF THE INVENTION

The present invention, generally, relates to multi-ply panels that are biodegradable and free of formaldehyde and more particularly to multi-ply panels with soy based adhesive systems.

### BACKGROUND OF THE INVENTION

Urea-Formaldehyde (UF) resins are widely used as a binder for lignocellulosic material. These formaldehyde-based resins are inexpensive, colorless, and are able to cure fast to form a rigid polymer, thereby providing the finished product with excellent physical properties.

A serious disadvantage of UF resin-bonded wood products is that they slowly emit formaldehyde into the surrounding environment. These emissions are commonly referred to as the Volatile Organic Compounds (VOCs). Due to environmental, health, and regulatory issues related to formaldehyde emissions from wood products, there is a continuing need for alternative formaldehyde-free binders. Recent legislation has prohibited or severely restricted the use of formaldehyde in one or more states.

A number of formaldehyde-free compositions have been developed for use as a binder for making wood products.

U.S. Pat. No. 4,395,504 discloses the use of formaldehyde-free adhesive system prepared by a reaction of a cyclic urea with glyoxal, for the manufacture of particleboard. Such a system, however, showed a rather slow cure and required acidic conditions (low pH) for the cure.

U.S. Pat. No. 5,059,488 shows an advantage of glutaraldehyde over glyoxal, when used in a reaction with cyclic urea. The patent discloses the use of glutaraldehyde-ethylene urea resins for wood panel manufacture. It was shown that this resin cured faster than glyoxal-ethylene urea resin, and the cure can be performed at a relatively high pH. However, the glutaraldehyde-based resins are not economically feasible.

U.S. Pat. No. 4,692,478 describes a formaldehyde-free binder for particleboard and plywood prepared of carbohydrate raw material such as whey, whey permeate, starch and sugars. The process comprises hydrolysis of the carbohydrate by a mineral acid, and then neutralizing the resin by ammonia. Although the raw materials are cheap and renewable, the reaction has to be performed at about 0.5. The pH makes handling difficult, dangerous, and costly.

U.S. Pat. No. 6,822,042 also discloses the use of a carbohydrate material (corn syrup) for preparing a non-expensive wood adhesive. Advantages of this binder include strong bonding, low cost, and renewable raw material. However, this adhesive requires the use of isocyanate as a cross-linker for this composition. Isocyanates are toxic making the use as a substitute for formaldehyde undesirable.

U.S. Pat. No. 6,599,455 describes a formaldehyde-free binder for producing particleboard containing curable thermoplastic co-polymers and cross-linkers selected from epoxy, isocyanate, N-methylol and ethylene carbonate compounds. Such compositions provide good strength and water resistance when cured. The epoxys are economically unfeasible do to the high material cost.

U.S. Pat. No. 6,348,530 describes a formaldehyde-free binder for producing shaped wood articles comprising a mixture of hydroxyalkylated polyamines and polycarboxylic acids. The binder preparation requires difficult steps to product and as a result is not economically viable.

Thus, there is a need for formaldehyde-free aqueous compositions suitable for use as a binder for wood products, such as plywood or particleboard. It is desirable that such curable compositions contain relatively high amount of non-volatiles, and at the same time are stable, fast-curing and do not emit any toxic fumes during the cure and afterwards. It would be desirable for the product to be made entirely of natural ingredients that are not harmful to the environment when placed in a landfill. The present invention satisfies one or more these and other needs.

### SUMMARY OF THE INVENTION

The present invention includes a panel comprising a first ply of a biodegradable wood or bamboo and a layer comprising a resin comprising cured soy protein that is optionally impregnated into a fiber containing structure. The multiply panel is biodegradable. It is preferably made entirely of renewable materials. It is preferably free of toxic materials, including formaldehyde based adhesives. In one embodiment, the first ply is wood. Typically, the structure is a sheet or mat. Preferably, the first ply is softwood. Typical softwoods are selected from the group consisting of fir, pine, spruce, cedar, redwood, or combinations thereof. In another embodiment, the first ply is a hardwood. Typical hardwoods are selected from the group consisting of maple, oak, elm, cherry, walnut, mahogany, teak, poplar, birch, wenge, beech, alder, hickory, ash, sapele or combinations thereof.

In another embodiment, the first ply is made of bamboo.

In another embodiment of the present invention, there includes a panel comprising a first ply of biodegradable wood or bamboo and a layer comprising cured soy protein and a strengthening agent.

In yet another embodiment, the fibrous biodegradable structure is made from fibers selected from the group consisting of kenaf, jute, ramie, sisal, linen, hem, kapok, flax fibers and combinations thereof.

The panel of one embodiment further comprises a second ply made of wood or bamboo. Typically, the second ply is made of wood. In another embodiment, the second ply is made of bamboo.

In one embodiment, one of the first ply or the second ply defines the outer surface of the panel.

The resin contains from about 99.5% to 40% by weight soy protein in one embodiment. In another embodiment, the resin comprises a strengthening agent. In still another embodiment, the strengthening agent comprises a carboxy-containing polymer that is optionally selected from a group consisting of agar, gellan and mixtures thereof.

In another embodiment, the strengthening agent comprises liquid crystal cellulose.

Preferably, the carboxy-containing polymer is present in an amount ranging from about 5 wt. % to about 50 wt. % In another embodiment, the resin further comprises glycerol, preferably, (or sorbitol, etc.) in an amount that is a minimum of about 0.5 wt. % to about 40 wt. %.

In still another embodiment, the resin comprises nanoclay or other suitable nanoparticles.

Alternatively, the resin further comprises microfibers and nanofibers.

Preferably, the wood based lignocellulosic material is selected from the group consisting of pine, fir, spruce, cedar, redwood, poplar, birch or combinations thereof. In another embodiment, the wood is selected from the group consisting of maple, oak, elm, cherry, walnut, mahogany, teak, poplar, birch, wenge, beech, alder, hickory, ash, sapele or combinations thereof.

In one embodiment, the multi-ply panel the length of the panel is a minimum of 1.5 feet, 2 feet, 2.5 feet, 3 feet, 4 feet, 5, feet, 6 feet, 7 feet, 8 feet or 9 feet and/or the width of the panel is a minimum of 6 inches, 1 foot, 2 feet, 2.5 feet, 3 feet, 3.5 feet, 4 feet or 4.5 feet.

In an embodiment, the panel is used for the manufacture of furniture and as a building material. Specifically, the panel of one embodiment is used as a replacement for wood, plywood, fiberboard, or oriented strand board.

In another application, the panel is used for the manufacture of board sports applications such as skateboards, skim boards, wakeboards, water-skis, boogie boards, surfboards and snowboards, snow skis, wake skates, snow skates.

In one embodiment the ply is selected from the group consisting of bamboo, birch, maple and combinations thereof. The fiber structure is a biodegradable fiber mat (preferably from a natural yearly renewable source). The resin comprises soy polymer. Preferably, in one embodiment, the first ply is a bamboo ply, that is laminated to a second ply of maple by a second biodegradable fiber mat (preferably from a yearly renewably source).

In another embodiment, the first ply is maple that is adhered to a second ply selected from the group consisting of birch, poplar, spruce and combinations thereof with a biodegradable mat that is impregnated with a soy protein resin. A third ply is adhered to one of the first ply and the second ply by a second biodegradable mat impregnated with soy protein. Optionally, the third ply is adhered to one of the first ply and the second ply by a poly (vinyl acetate) adhesive.

In one embodiment, the present invention is a first ply of wood or bamboo (“veneer”) that is adhered to one or more layers of fiber mats or sheets that are impregnated with soy based fibers. In one embodiment, the laminate is hardwood, softwood or bamboo. Specifically, any one of the specific species of hardwood, softwood or bamboo listed above is preferred.

In another application, the panel is used for wall panels, wall trim including baseboards, molding.

In another application, the panels are used in the manufacture of furniture including cupboards, shelves, cabinets, chests, chairs and other seats, beds, tables, stands, dog furniture, and vanities.

In another embodiment, the multi-ply panel is used as a building material for e.g., homes, offices, storage buildings, manufacturing facilities.

In another embodiment, the first ply and the third ply are adjacent and are adhered together with poly (vinyl acetate).

### DETAILED DESCRIPTION OF THE INVENTION

### Definitions

The term “biodegradable” is used herein to mean degradable over time by water and/or enzymes found in nature (e.g. compost), without harming, and in fact helping, the environment.

The terms “biodegradable resin” and “biodegradable composite” are used herein to mean that the resin and composite are sustainable and at the end of their useful life, can be disposed of or composted without harming, and in fact helping, the environment.

The term “stress at maximum load” means the stress at load just prior to fracture, as determined by the stress-strain curve in a tensile test.

The term “fracture stress” means the stress at fracture as determined by the stress-strain curve in a tensile test.

The term “fracture strain” means the strain (displacement) at fracture, as determined by the stress-strain curve in a tensile test.

The term “modulus” means stiffness, as determined by the initial slope of the stress-strain curve in a tensile test.

The term “toughness” means the amount of energy used in fracturing the material, as determined by the area under the stress-strain curve.

The “tensile test” referred to is carried out using Instron or similar testing device according to the procedure of ASTM Test No. D882 for resin sheets and D3039 for composites. Testing is carried out after 3 days conditioning at 21° C. and 65% relative humidity.

The term “strengthening agent” is used herein to describe a material whose inclusion in the resin results in an improvement in any of the strength characteristics of the cured biodegradable polymeric composition of the present invention without preventing the resin from being pourable in the uncured form. The improvement in strength characteristics could include “stress at maximum load”, “fracture stress”, “fracture strain”, “modulus” and “toughness” measured for a solid article formed by curing of the composition. The improvement can be compared with the corresponding strength characteristic measured for a cured solid article obtained from a similar resin lacking the strengthening agent.

The term “curing” is used herein to describe subjecting the composition of the present invention to conditions of temperature and effective to form a solid article having a moisture content of preferably less than about 0.5 wt. %.

The phrase “free of toxic chemicals” or “toxic chemical free” means the materials used do not contain toxic or carcinogenic chemicals or a compound that will release formaldehyde in the manufacturing process or during the effective life of the product.

### The Wood or Bamboo Plies

The present invention includes plies of wood and/or bamboo. The plies are oriented into layers. Each layer has a grain associated with the layer. Typically, the multiple layers are oriented so that the grain of each layer is generally at a different angle from at least one other layer. In one embodiment, one ply is located at a ninety degree angle from another ply. When multiple plies are used a repeated pattern of overlaying the plies at ninety degrees from the adjacent ply. In another embodiment, one ply is placed at an angle that is 30 degrees from the adjacent ply. Optionally, the one ply is placed at a 45 degree angle or a 60 degree angle from the adjacent ply.

In another embodiment, there are at least three plies in the plyboard. One ply is oriented in a first direction. The second board is oriented at 45 degrees from the first direction. The third board is oriented 125 degrees from the first direction. Generally, in this embodiment, the first direction is oriented along the general length of the plyboard.

In another embodiment, there are at least three plies of wood and/or bamboo in the plyboard. In one embodiment, there is a a ply that oriented in a first direction. A second ply is oriented in a second direction at an angle of 30 degrees from the first direction. A third ply is oriented in a third direction at an angle of 60 degrees from the first ply. In one embodiment, the first direction is oriented along the general length of the ply board. In another embodiment, the second direction is oriented along the general length of the plyboard.

Non-wood material includes plies of bamboo. Wood-based materials include both hardwood and softwood. Suitable types of hardwood include oak, maple, ash, buckeye, butternut, beech, birch, cherry, chestnut, elm, hickory, sycamore, walnut, poplar, basswood, arnecan, cottonwood, hackberry, pecan, honey locust, black locust, magnolia, sassafras, sweetgum, tupelo, mahogany willow, teak, birch, wenge, alder, sapele and combinations thereof. Suitable types of soft-wood include cedar, fir, hemlock, larch, pine, redcedar, redwood, spruce, tamarack, cypresspoplar, birch or combinations thereof.

In one embodiment, a ply is attached as a veneer. Wood for a veneer ply includes but are not limited to any hardwood, softwood or bamboo that is listed above. Preferably, the veneer is bamboo, pine, white maple, red maple, poplar, walnut, oak, redwood, birchwood, mahogany, ebony, cherry wood, etc. Preferable wood for a veneer ply include but are not limited to cherry, birch, walnut, maple, oak or mahogany.

In another embodiment, the plies are for building materials and include but are not limited to bamboo, pine, mahogany, white maple, red maple. The plies, typically, are cut to a thickness that is a minimum of about 0.1 mm, about 0.3 mm, about 0.5 mm, about 1 mm, about 2 mm or about 3 mm and is a maximum of about 10 mm, about 8 mm, about 6 mm, about 5 mm, about 4 mm, about 3 mm or about 2 mm. The length and width of the panels, boards or sheets are preferably the size of the resulting panels.

### The Fiber Structure

In accordance with the present invention, the soy impregnated fiber structures are formed into generally two dimensional sheets of soy impregnated biodegradable, renewable natural fibers that when pressed between plies will form a layer.

In one embodiment, the structures include any biodegradable material that has fibers useful in making fabric, cords or string. Preferably the material is renewable, more preferably yearly renewable. In one embodiment, the biodegradable fibers are made of cotton, silk, spider silk, hemp, ramie, kenaf, sisal, burlap, flax, wool, hair or fur, jute or combinations thereof.

In one embodiment, the fibers are non-woven. Preferably, the polymers include a meltable, biodegradable polymer including but not limited to, poly (lactic acid) (PLA), poly (glycolic acid), poly (dioxanone), poly (trimethylene carbonate), poly (hydroxyalkanoates), poly (caprolactone) and combinations thereof.

In an embodiment, the fibers are formed into woven, nonwoven, knitted, or braided structures, typically sheets. These fibers can be oriented in 100% warp, plus and minus 30-45 degree, a combination thereof, any breakdown of warp and weft and other axis resulting in either bi- or tri-axial cloths. The structures are preferably of uniform thickness and water absorbent to facilitate easy impregnation of the structures by soy based resin. In one embodiment the structures are nonwoven and have a mass per area that is a minimum of about 100 g/m², about 200 g/m² or about 300 g/m² and/or a maximum of about 500 g/m², about 600 g/m² or about 800 g/m².

In one preferred embodiment, the structures are nonwoven and are made of natural fibers (e.g. kenaf fibers) that are blended with a meltable biodegradable polymer (e.g. poly (lactic acid), poly (hydroxyalkanoates), etc.) and heat pressed into a nonwoven fiber mat of uniform thickness. The poly (lactic acid) readily melts during the heat press stage and binds the kenaf fibers together. Other degradable fibers, e.g. wool, viscose rayon, lyocell, etc., may also be blended.

### Resin

The resin is made entirely of biodegradable materials. Preferably the materials are from a renewably source including a yearly renewable source. None of the ingredients in the resin should be toxic to the human body. Particularly, none of the ingredients should be general irritants, toxins or carcinogens. The resin does not include formaldehyde or urea derived materials. In one embodiment, the resin includes soy protein. In another embodiment, the resin further includes a strengthening agent. In one embodiment, the strengthening agent is soluble (i.e., substantially soluble in water at a pH of about 7.0 or higher). In one embodiment, the strengthening agent is a polysaccharide. Preferably, the polysaccharide is a carboxy-containing polysaccharide. In one preferred embodiment, the strengthening agent is selected from the group consisting of agar, gellan, and mixtures thereof.

The resin can include additional strengthening agents of natural origin that can be a particulate material, a fiber, or combinations thereof. The strengthening agent may be, for example, a liquid crystalline (LC) cellulose fiber, nanoclay, microfibrillated cellulose nanofibrillated cellulose and combinations thereof.

Further, in accordance with the present invention, a composition containing gellan and soy protein can be employed together with natural and high strength liquid crystalline (LC) cellulosic fibers to form biodegradable composites. The LC cellulose fibers can be produced by dissolving cellulose in highly concentrated phosphoric acid to form a LC solution of cellulose, as described in Borstoel, H., “Liquid crystalline solutions of cellulose in phosphoric acid,” Ph. D. Thesis, Rijksuniversiteit, Groningen, Netherlands, (1998). The resulting LC cellulose solution was spun using an air gap-wet spinning technique to obtain highly oriented and crystalline cellulose fibers that had strengths in the range of 1700 MPa.

Preferably, the weight ratio of soy protein: strengthening agent in the biodegradable polymeric composition of the present invention is about 20:1 to about 1:1. The composition may also include a plasticizer, the weight ratio of plasticizer: (soy protein+first strengthening agent) preferably being about 1:20 to about 1:4. In a preferred embodiment, the plasticizer comprises glycerol.

The biodegradable polymeric composition of the present invention preferably is substantially free of starch in one embodiment. Also, although many soy-based polymeric compositions of the prior art include supplementary crosslinking agents such as, for example, acid anhydrides, isocyanates, and epoxy compounds, compositions of the present invention are preferably substantially free of such supplementary crosslinking agents.

Soy protein has been modified in various ways and used as resin in the past, as described in, for example, Netravali, A. N. and Chabba, S., Materials Today, pp. 22-29, April 2003; Lodha, P. and Netravali, A. N., Indus. Crops and Prod. 2005, 21, 49; Chabba, S. and Netravali, A. N., J. Mater. Sci. 2005, 40, 6263; Chabba, S. and Netravali, A. N.,

J. Mater. Sci. 2005, 40, 6275; and Huang, X. and Netravali, A. N., Biomacromolecules, 2006, 7, 2783.

Soy protein contains between about 18-20 different amino acids, including those that contain reactive groups such as —COOH, —NH₂ and —OH groups. Once processed, soy protein itself can form crosslinks through the —SH groups present in the cysteine amino acid as well as through the dehydroalanine (DHA) residues formed from alanine by the loss of side chain beyond the β-carbon atom. DHA is capable of reacting with lysine and cysteine by forming lysinoalanine and lanthionine crosslinks, respectively. Asparagines and lysine can also react together to form amide type linkages. All these reactions can occur at higher temperatures and under pressure that is employed during curing of the soy protein.

In addition to the self-crosslinking in soy protein, the reactive groups can be utilized to modify soy proteins further to obtain desired mechanical and physical properties. The most common soy protein modifications include: addition of crosslinking agents and internal plasticizers, blending with other resins, and forming interpenetrating networks (IPN) with other crosslinked systems. Without being limited to a particular mechanism of action, these modifications are believed to improve the mechanical and physical properties of the soy protein resin.

The properties (mechanical, physical, and thermal) of the soy protein resins can be further improved by adding nanoclay particles and micro- and nano-fibrillar cellulose (MFC, NFC), as described in, for example, Huang, X. and Netravali, A. N., “Characterization of flax yarn and flax fabric reinforced nano-clay modified soy protein resin composites,” Compos. Sci. and Technol., 2007 67, 2005; and Netravali, A. N.; Huang, X.; and Mizuta, K., “Advanced green Composites,” Advanced Composite Materials, 2007, 16, 269.

Gellan, a linear tetrasaccharide that contains glucuronic acid, glucose and rhamnose units, is known to form gels through ionic crosslinks at its glucuronic acid sites, using divalent cations naturally present in most plant tissue and culture media. In the absence of divalent cations, higher concentration of gellan is also known to form strong gels via hydrogen bonding. The mixing of gellan with soy protein isolate has been shown to result in improved mechanical properties. See, for example, Huang, X. and Netravali, A. N., Biomacromolecules, 2006, 7, 2783 and Lodha, P. and Netravali, A. N., Polymer Composites, 2005, 26, 647.

Gellan gum is commercially available as Phytagel™ from Sigma-Aldrich Biotechnology. It is produced by bacterial fermentation and is composed of glucuronic acid, rhanmose and glucose, and is commonly used as a gelling agent for electrophoresis. Based on its chemistry, cured Phytagel™ is fully degradable. In preparing a composition of the present invention wherein cured gellan gum is the sole strengthening agent, Phytagel™ is dissolved in water to form a solution or weak gel, depending on the concentration. The resulting solution or gel is added to the initial soy protein powder suspension, with or without a plasticizer such as glycerol, under conditions effective to cause dissolution of all ingredients and produce a homogeneous composition.

In one embodiment, at least two plies are affixed to each other by a layer of soy protein containing resin impregnating a fiber structure, including a fiber matt. Optionally, at least two plies are further adhered with a biodegradable poly (vinyl acetate) adhesive.

### Method of Making Resin

A biodegradable resin in accordance with the present invention may be prepared by the following illustrative procedure:

Into a mixing vessel at a temperature of about 70-85° C., is added 50-150 parts water, 1 part glycerol, 10 parts soy protein concentrate or isolate, and 1-3 parts gellan or agar. To the mixture is added, with vigorous stirring, a sufficient amount of aqueous sodium hydroxide to bring the pH of the mixture to about 11. The resulting mixture is stirred for 10-30 minutes, and then filtered to remove any residual particles. Optionally, clay nanoparticles and/or cellulose nanofibrils (NFC), microfibrils (MFC), may be added to the resin solution as additional strengthening agents.

### Method of Making Impregnated Fiber Structures

The resin solution so produced is used to impregnate and coat one or more fiber structures. The structures may comprise, for example, kenaf, jute, sisal, ramie, kapok, flax, or hemp fiber; fabric sheets may comprise, for example, flax.

Resin solution is applied to a fiber structure such as a mat or sheet in an amount of about 50-100 ml of resin solution per 15 grams of fiber structure so as to thoroughly impregnate the structure and coat its surfaces. The fiber structure so treated is pre-cured by drying in an oven at a temperature of about 35-70° C. to form what is referred to sometimes as a prepreg. Alternatively, the structure is dried on one or more drying racks at room temperature or at outdoor temperature. In one embodiment, the fiber structure for adhering one ply to another ply is in the form of a sheet or mat. Preferably, the sheet or mat is of uniform thickness and has an even distribution of resin during the impregnation process. Accordingly, when a sheet or mat is pressed between two layers of wood and/or bamboo the overall thickness is constant throughout the overall area of the ply board.

### Method of Making Ply Boards

Ply boards may have a minimum of 1, 2, 3, 4 or 5 plies and a maximum of 11, 10, 9, 8, 7, 6, 5 or 4 plies. A ply board is a layer of thinly cut wood or bamboo. As noted the desired number of plies are arranged and oriented with a grains in the desired position. Preferably, in one embodiment, the outer layer of the multi-ply sheet is a wood or bamboo ply so that the resulting multi-ply material has the outward appearance of a wood or bamboo article. However, in another embodiment, the outer layers are soy impregnated biodegradable fiber structures.

In one embodiment, the multi-ply boards include but are not limited to bamboo, birch, and maple. The biodegradable structure is a woven or non-woven fiber mat. The resin comprises soy protein. In one embodiment, the first ply is bamboo, the second ply is maple. The first ply and the second ply are adhered together by a biodegradable mat impregnated with soy protein.

In one embodiment, the first ply is maple. The second ply is one of birch, poplar and spruce. The second ply is adhered to first ply by a biodegradable mat. The embodiment further comprises a third ply that is adhered to the second ply by a biodegradable mat that is impregnated with soy protein resin. Optionally, the third ply is adhered to a second ply by a poly (vinyl acetate) adhesive.

The multi-ply board of one embodiment comprises a first ply a second ply and a third ply. At least one of the first ply, second ply and third ply is adhered to another of the first ply, second ply or a third ply by a soy protein resin impregnated into a fiber mat or sheet. Optionally, at least one ply is adhered by a poly (vinyl acetate) adhesive. The multi ply board of one embodiment is selected from the group comprising birch, poplar and spruce. Preferably, there is an additional veneer layer that is adhered to one of the first ply, second ply or third ply by either a poly (vinyl acetate) adhesive or a fiber structure comprising a mat or sheet that is impregnated with soy protein resin.

It is likewise preferable, according to one embodiment to use two or more soy impregnated biodegradable structures in a single layer. The two or more soy impregnated biodegradable structures are formed into a sheet-like structure and are pressed together into a single layer. A single layer of soy impregnated biodegradable fibers will include a minimum of one sheet, two sheets, three sheets, four sheets or five sheets of soy impregnated, biodegradable fibers and a maximum of five sheets, four sheets and three sheets of soy impregnated biodegradable fibers.

In one embodiment, the ply material is a three ply sheet having a first ply of wood and/or bamboo, a second layer comprising a minimum of 2 and a maximum of 5 sheets of prepreg mats and a second ply comprising wood and/or bamboo. The plies are stacked as described above and are subject to high pressure and temperature to cure. By way of example, the stack is hot pressed for 2-10 minutes at about 80° C. and a load of 0.5-1 MPa. Following a rest period of about 5 minutes, the stack is hot pressed for 5-15 minutes at 120-130° C. and a load of2-10 MPa, followed by removal from the press. The resulting solid article has the appearance of three ply wood sheets and exhibits excellent strength properties.

In another embodiment, the material is a multi-ply sheet that is made of four plies of wood and/or bamboo and three layers of soy-impregnated, biodegradable fiber that is made from two sheets of soy-impregnated, biodegradable fibers. The two outer plies (first and fourth plies) are wood veneers such as hardwood veneers. The layers of plies and composites are stacked as follows:

HV-SF-SF-HW-SF-SF-HW-SF-SF-HV,

wherein HV is hardwood veneer, SF is a soy-impregnated, biodegradable fiber sheet, HW is a hardwood layer. The board has the appearance of hardwood, has excellent strength properties and is useful for applications in manufacture of furniture. In one embodiment, the hardwood is maple.

In another embodiment, the layers of plies and composites are as follows

HV-SF-HW-SF-HV

In still another embodiment, the layers of plies and composites are illustrated as follows:

HV-SF-HW-SF-HW-SF-HV

In still another embodiment, the layers of plies and composites are illustrated as follows:

MV-BP-SF-BP,

where MV is maple veneer and BP is a bamboo ply.

One embodiment includes layers of plies and composites arranged as follows:

MV-BP-PVA-BP-SF-BP-BP,

wherein PVA is poly (vinyl acetate) adhesive.

In another embodiment, the layers are illustrated as follows:

SW-SF-SW,

wherein SW is softwood.

In still another embodiment, the layers are illustrated as follows:

SW-SF-SW-SF-SW.

Many softwood (SW) varieties could also be used in place of HW and many HW examples can be used in place of SW in one embodiment. Softwood veneers and Hardwood veneers can replace any of the outer layers listed above.

A biodegradable composite article of the present invention may comprise a first ply of wood and/or bamboo veneer that is affixed to a thermoset composite comprising a soy-impregnated, composite fiber layer. The veneer and fiber layers are pressed in the form of a flat board. The thermoset sheet may be corrugated.

The corrugated sheet may be formed using a conventional thermoforming molding process, using apparatus described in U.S. patents classified in class 425, subclasses 369 (apparatus wherein reshaping means creates accordion-like pleats or wrinkles or the like in a preform by distorting a section thereof transverse to its axis into a plurality of reversing curves) and 336 (apparatus comprising means for shaping an advancing length of work into ridges and grooves). The corrugation may be paper material or is alternatively thermoset composite comprising soy impregnated composite fiber.

Also envisioned in accordance with the present invention are biodegradable composite solid articles that comprise a stacked array of biodegradable composite sheets containing both flat and corrugated sheets. For example, the array could include a middle corrugated sheet disposed between and adhered to two flat sheets, providing bending stiffness in the direction of the corrugations. In another configuration, two superimposed corrugated sheets whose corrugations are orthogonal to one another are secured between two flat outer sheets, resulting in a structure of enhanced stiffness in both directions.

Also in accordance with the present invention, a biodegradable molded thermoset polymeric article is obtained by subjecting the biodegradable polymeric composition described above to conditions of temperature and pressure effective to form the thermoset polymeric article. Effective temperature and pressure conditions preferably include a temperature of about 35° C. to about 130° C. and a pressure of about 0.1 MPa to about 20 MPa, more preferably, a temperature of about 80° C. to about 120° C. and a pressure of about 2 MPa to about 20 MPa.

In one preferred embodiment, the ply board comprising wood and/or bamboo ply affixed to a layer of soy impregnated fiber articles comprise a thermoset layer is shaped and contoured by a mold. In one embodiment, the shape is contoured to form a skateboard.

Skateboards are pre configured in multiple plies and layers prior to pressing. One or more of the layup configurations described above are used. In one embodiment, the plies are offset from one another plus or minus an angle ranging from about 28 degrees to about 47 degrees—preferably about 30 degrees or about 45 degrees. The plies are pressed according to the temperatures and pressures listed above to form a blank (precut skateboard). In one embodiment, the layup combination is pressed under pressures ranging from about 80 psi to about 200 psi with heat from about 35 C to about 130 C. The time of pressing ranges from about 8 minutes to about 30 minutes. The blank can be of one or more 3 dimensional shapes consisting of concavity, convexity, tip and tail up turned, camber, rocker, and any combination thereof.

The press is contoured to the desired shape and results in a contoured blank.

Board layups of one embodiment consist of bamboo, soy protein impregnated biodegradable mat, maple.

Another layup includes vertlam hardwood core, soy protein impregnated biodegradable mat, and maple veneer.

In another embodiment, the layup includes at least one bamboo layer and at least one soy protein impregnated biodegradable mat.

In another embodiment, the layup includes at least one layer of bamboo at least one layer of soy impregnated biodegradable mat and at least one veneer of maple.

In yet another embodiment, the layup includes a vertlam hardwood core and a soy impregnated biodegradable mat,

Optionally, one or more layers can be fixed with a poly(vinyl acetate) glue such as Titebond®, Titebond® II or Titebond® III brand adhesives provided that at least one layer of the layup is a soy protein that is impregnated into a biodegradable mat or sheet.

Once the blanks are pressed they can be further shaped with saws, routers and sanders.

After the shaped boards are then sealed with clear coat. They can be painted or decorated with silk screen design transfers or heat transferred decals. Examples of shapes and designs of skateboard are available at www.cometskateboards.com.

### EXAMPLES

### Example 1

### Bamboo Plies Sample Preparation

To compare the properties of the e2e resin to that of Titebond® II wood glue to adhere samples of bamboo ply, several samples were prepared according to the following procedure.

For this experiment three different resins were made for comparison to state of the art commercial wood glue. The first resin (R-1) was made with 10 parts phytagel and 10 parts glycerol per 100 parts of soy protein isolate. The second resin (R-2) by weight of SPI and one with 20 parts phytagel, 10 parts glycerol per 100 parts soy protein isolate.

First, 250 ml of water were mixed with 25 g of soy protein isolate. Next, 10 parts phytagel and 10 parts of glycerol were added was added to the resin, R-1. Twenty parts phytagel and 10 parts of glycerol were added to the resin, R-2. Both resins were heated. Then, the resins were stirred for 30 min with no heat. Next, the resins were moved to a hot water bath at 80° C. and were stirred for 30 min. After this, the resins R-1 and R-2 were allowed to cool slightly for easier handling and then used as an adhesive on bamboo samples.

Titebond® II wood glue was obtained from Franklin, International of Columbus, Ohio and designated R-3.

### Example 2

### Lap Shear Test

The bamboo samples were cut into usable size squares of different sizes all approximately 6″×7″. Then, the surface was treated as follows: Several bamboo samples referenced herein as B-1 were belt sanded until the top surface was evenly roughed up. Several additional samples were wire brushed with a circular wire until the surface was evenly scored by the wire brush. The wire brushed samples are referenced as B-2. Several bamboo samples were untreated and are identified as B-4.

Various samples from each of the four groups of B-1, B-2 and B-4 were adhered using R-1, R-2 and R-3 as set forth in Table 1 below. Two samples using the same resin and surface preparation were oriented to have a 2 inch overlap and were then heat pressed together in a two-step hot press process. During the first step, the samples were pressed for 10 min at 80° C. under 5 tons pressure. In step two, the samples were pressed for 20 min at 120° C. and 50 tons. The pressed samples were then cut into approximate 1″ strips. The actual dimensions of each sample were recorded for calculation of the lap test max load.

The samples were attached to the Instron testing machine and were pulled apart using a force that is parallel to the plane of adhesion. The force required to pull the two boards apart is referred to as the shear test max load. The data for these tests are as follows:

TABLE 1
Results of Lap Sheer Test for Bamboo Plies

| | | Number | |
|---|---|---|---|
| | | of | Shear Test |
| | | Samples | Max. Load |
| Resin | Sample | Tested | (PSI) |
| 20 Parts Phytagel Soy | Bamboo with no | 0 | ND |
| Protein Resin (R-2) | treatment (B-4) | | |
| 20 Parts Phytagel Soy | Sanded Bamboo (B-1) | 5 | 176 |
| Protein Resin (R-2) | | | |
| 20 Parts Phytagel Soy | Wire brushed Bamboo | 4 | 345 |
| Protein Resin (R-2) | (B-2) | | |
| 10 Parts Phytagel Soy | Bamboo with no | 3 | 379 |
| Protein Resin (R-1) | treatment (B-4) | | |
| 10 Parts Phytagel Soy | Sanded bamboo(B-1) | 4 | 296 |
| Protein Resin (R-1) | | | |
| 10 Parts Phytagel Soy | Wire brushed bamboo | 3 | 385 |
| Protein Resin (R-1) | (B-2) | | |
| Titebond ® II (R-3) | Bamboo with no | 0 | ND |
| | treatment (B-4) | | |
| Titebond ® II (R-3) | Sanded bamboo (B-1) | 3 | 251 |
| Titebond ® II (R-3) | Wire brushed treated | 3 | 252 |
| | bamboo (B-2) | | |

The data gathered from this test shows that e2e Materials, Inc. soy protein resin performs reasonably well and has, in fact, superior performance than the industry standard in wood adhesives. The best performance was found with the soy protein resin with 10 parts phytagel for 100 parts of soy protein and a bamboo ply surface that was prepared with wire brush surface preparation, a max load of 385 psi. The best result from the Titebond® II was using the wire brush surface prep; max load of 252 psi.

What is claimed is:

1. A panel comprising:
a first ply of wood and/or bamboo;
a layer comprising a fibrous biodegradable structure that is impregnated with a resin comprising cured soy protein.

2. The panel of claim 1, wherein the first ply is wood.

3. The panel of claim 1, wherein the first ply is made of bamboo.

4. The panel of claim 1, wherein the biodegradable structure is made from fibers selected from the group consisting of kenaf, hemp, jute, ramie, sisal, kapok, flax fibers and combinations thereof.

5. The panel of claim 1, further comprising a second ply of made of wood.

6. The panel of claim 1, wherein the biodegradable structure is a sheet or mat.

7. The panel of claim 5, wherein the first and second ply define the outer surface of the panel.

8. The panel of claim 5, wherein the first and second ply define the outer surface of the panel.

9. The panel of claim 1, wherein the cured resin comprises 99.5% to 40% by weight soy protein.

10. The panel of claim 1, wherein the cured resin includes a strengthening agent.

11. The panel of claim 10, wherein the strengthening agent comprises a carboxy-containing polymer selected from a group consisting of agar, gellan and mixtures thereof.

12. The panel of claim 10, wherein the strengthening agent is present in an amount ranging from about 5 wt. % to about 50 wt. %

13. The panel of claim 10, wherein the resin further comprises glycerol in an amount that is a minimum of about 0.5 wt. % to about 40 wt. %.

14. The panel of claim 10, wherein the strengthening agent further comprises nanoclay or other suitable nanoparticles.

15. The panel of claim 11, wherein the fiber material further comprises microfibers and nanofibers.

16. The panel of claim 2, wherein the wood is selected from the group consisting of fir, pine, spruce, cedar, redwood, or combinations thereof.

17. The panel of claim 2, wherein the wood is selected from the group consisting of maple, oak, elm, cherry, walnut, mahogany, teak, poplar, birch, wenge, beech, alder, hickory, ash, sapele or combinations thereof.

18. The panel of claim 1, wherein the length of the panel is a minimum of 2 feet and the width of the panel is a minimum of 0.5 feet.

19. The panel of claim 1, wherein the length of the panel is a minimum of 4 feet and the width is a minimum of 2 feet.

20. The panel of claim 1, wherein the length of the panel is a minimum of about 8 feet and the width of the panel is a minimum of about 4 feet.

21. The panel of claim 1, wherein the panel is used for the manufacture of furniture and other applications as replacement of wood, plywood, fiberboard or oriented strand board.

22. The panel of claim 1, wherein the panel is used for the manufacture of skateboards and other board sports applications such as skateboards, skim boards, wakeboards, water-skis, boogie boards, surfboards and snowboards, snow skis, wake skates and snow skates.

23. The panel of claim 1, wherein the panel is used in building homes.

24. The multi-ply panel of claim 1, further comprising at least two plies.

25. A skateboard comprising bamboo plies laminated with a biodegradable composition comprising soy protein.

26. A skateboard comprising bamboo plies laminated with cured soy protein impregnated into biodegradable fibers.

27. The skateboard of claim 26, comprising a first ply of hardwood and a second ply of bamboo, a third ply of bamboo and a fourth ply of bamboo, wherein at least two plies of bamboo and/or hardwood are affixed together by a layer comprising a biodegradable fiber structure impregnated with soy protein.

28. The skateboard of claim 27, wherein at least two plies of hardwood and/or maple are adhered by a layer of poly (vinyl acetate) adhesive.

29. A composite comprising laminated plies of wood and a biodegradable fiber structure impregnated with soy protein resin.
